(19) United States
(12) Patent Application Publication
(10) Pub. No.: US 2018/0334117 A1
(43) Pub. Date: Nov. 22, 2018

(54) VEHICULAR WIRE HARNESS STRUCTURE

(71) Applicant: Yazaki Corporation, Tokyo (JP)

(72) Inventors: Mototatsu MATSUNAGA, Makinohara-shi (JP); Yoichi MAKI, Makinohara-shi (JP)

(73) Assignee: Yazaki Corporation, Tokyo (JP)

(21) Appl. No.: 16/050,607

(22) Filed: Jul. 31, 2018

Related U.S. Application Data
(63) Continuation of application No. PCT/JP2017/007095, filed on Feb. 24, 2017.

(30) Foreign Application Priority Data
Feb. 25, 2016 (JP) 2016-034820

(51) Int. Cl. B60R 16/03; B60R 16/02

(52) U.S. Cl. CPC B60R 16/03; B60R 16/0215

(57) ABSTRACT

A vehicular wire harness structure includes a first wire harness configured to connect a first electrical component and a main control function portion, the first electrical component being attached to a vehicle, the main control function portion controlling the first electrical component, and a second wire harness that has one end connected to the main control function portion. The second wire harness has a sub control function portion that is provided at the other end of the second wire harness to control a second electrical component. A function for serving as a master to make a data communication with the sub control function portion which serves as a slave is installed in advance into the main control function portion and the main control function portion has no function to control the second electrical component.

### CROSS REFERENCE TO RELATED APPLICATIONS

This application is a continuation of PCT application No. PCT/JP2017/007095, which was filed on Feb. 24, 2017 based on Japanese Patent Application (No. 2016-034820) filed on Feb. 25, 2016, the contents of which are incorporated herein by reference.

### BACKGROUND OF THE INVENTION

### 1. Field of the Invention

The present invention relates to a vehicular wire harness structure.

### 2. Description of the Related Art

In addition to a device directly related to travelling of a vehicle such as a car, various auxiliary devices (auxiliary machines: accessories) are mounted on the vehicle. For example, electrical components such as an air-conditioner, a wiper, a power window, an electrically driven seat, various lighting fixtures, a door lock device, a seat heater, and defrosting hot wires are mounted as the accessories on the vehicle.

Some of various electrical components belonging to the accessories are standard electrical components to be mounted on all vehicles, and the others are optional electrical components to be determined as to whether to be selectively mounted on each vehicle or not in accordance with a type, a grade and a destination of the vehicle, user's selection, etc. In addition, an electrical component carrying out a new function which was not assumed in original design of a vehicle may be additionally mounted on the vehicle.

Such various electrical components mounted on the vehicle are required to be controlled suitably respectively. Therefore, an electronic control unit (ECU) is generally connected with the respective electrical components through a wire harness mounted on the vehicle.

In an electronic device controlling system shown in JP-A-2011-93374, a controller for controlling standard electronic devices and a controller for controlling optional electronic devices are provided inside one electronic control unit. In addition, the electronic control unit and the standard electric devices are connected by a standard circuit included in a wire harness, and the electronic control unit and the optional electronic devices are connected by an optional circuit included in the wire harness. In addition, a communication connector is provided in the optional circuit.

In addition, in a wire harness structure body shown in JP-A-2013-15987, a joint connector is connected to one end of a wire harness the other end of which is connected to an electronic control unit, and wire harnesses of standard circuits and wire harnesses of optional circuits are connected to the joint connector. In addition, a communication circuit in which a CPU and a driver are built is provided in the joint connector.

In addition, in a wire harness shown in JP-A-2014-166019, an independent ECU (Electronic Control Unit) is provided for each electronic device. In addition, in an on-vehicle system shown in JP-A-2015-58768, a plurality of ECUs (Electronic Control Units) that control a plurality of electronic devices respectively are connected to different connectors respectively.

As described above, of electrical components belonging to accessories in an actual vehicle, some are standard electrical components and the others are optional electrical components. Of the optional electrical components, some are mounted on the vehicle and the others are not mounted on the vehicle. Therefore, an electronic control unit controlling the electrical components is usually mounted with only a standard function of controlling the standard electrical components but still has a sufficient reserve of processing capability. When the optional electrical components are mounted, a function of controlling the optional electrical components is also mounted in the same electronic control unit as the standard function, as in JP-A-2011-93374.

On the other hand, there is also a case where a new function or a new electrical component which was not assumed in design of the vehicle may be desired to be added to the on-vehicle system. In such a case, it is general that a standard electronic control unit ECU-B added with a special function for controlling the new function or electrical component is newly designed, and a standard electronic control unit ECU-A is replaced by the standard electronic control unit ECU-B, as shown in FIG. 8. Alternatively, in order to control the new function or electrical component, a separate electronic control unit ECU-C from the standard electronic control unit ECU-A is added, and the new electrical component is connected to the added electronic control unit ECU-C via a wire harness.

However, when the separate electronic control unit ECU-C is added to the standard electronic control unit ECU-A as shown in FIG. 8, the number of components is increased greatly to thereby lead to an expensive system. In addition, in order to be able to cope with addition of various functions by only one electronic control unit like the standard electronic control unit ECU-B, the standard electronic control unit must have a sufficient reserve of capability. This leads to an increase in cost. That is, when no optional electrical component is connected or no function is added, the standard electronic control unit has more capability than necessary. Therefore, the component cost of the standard electronic control unit is inevitably expensive in comparison with the function that is put in actual execution.

However, even when there is a possibility that any new function or any new electrical component may be added to the on-vehicle system, specifications of the function or electrical component to be added are unknown in the original design. Therefore, the reserve of capability of the standard electronic control unit cannot be optimized.

### SUMMARY OF THE INVENTION

The present invention has been accomplished in consideration of the aforementioned circumstances. An object of the present invention is to provide a vehicular wire harness structure useful for optimizing a system configuration in accordance with specifications of a function to be added or an electrical component to be added.

In order to attain the foregoing object, the vehicular wire harness structure according to the present invention is characterized by the following configurations (1) to (5).

(1) A vehicular wire harness structure including:

a first wire harness configured to connect a first electrical component and a main control function portion with each other, the first electrical component being attached to a vehicle, the main control function portion controlling the first electrical component; and

a second wire harness that has one end connected to the main control function portion,

wherein the second wire harness has a sub control function portion that is provided at the other end of the second wire harness to control a second electrical component attached to the vehicle.

According to the vehicular wire harness structure having the aforementioned configuration (1), when the second electrical component is added, the main control function portion does not have to take charge of processing of the second electrical component. Accordingly, the main control function portion does not have to have more capability than necessary. In addition, processing capability of the sub control function portion can be adjusted in accordance with specifications of the second electrical component. Therefore, an increase in component cost of the sub control function portion can be suppressed.

(2) A vehicular wire harness structure according to the aforementioned configuration (1), wherein the sub control function portion of the second wire harness has a single function that controls any one of a plurality of electrical components each of which serves as the second electrical component.

According to the vehicular wire harness structure having the aforementioned configuration (2), the sub control function portion can have only a specific single function suitable for the kind of the second electrical component which is actually connected. Therefore, the configuration of the sub control function portion can be optimized so that the component cost of the sub control function portion can be suppressed.

(3) A vehicular wire harness structure according to the aforementioned configuration (1), wherein the sub control function portion has a plurality of functions that control at least two of a plurality of electrical components each of which serves as the second electrical component, and controls the second electrical components connected to the sub control function portion.

According to the vehicular wire harness structure according to the aforementioned configuration (3), the plurality of the second electrical components can be controlled only when one sub control function portion is provided. Therefore, it is possible to avoid complicating the overall configuration of the wire harness or the configuration of a system.

(4) A vehicular wire harness structure according to any of the aforementioned configurations (1) to (3), wherein a plurality of wire harnesses each of which serves as the second wire harness are provided, and the plurality of the second wire harnesses are connected to the first wire harness respectively.

According to the vehicular wire harness structure having the aforementioned configuration (4), even when any new electrical component or function is added, it is unnecessary to entirely reproduce a new wire harness and replace the existing wire harness with the new wire harness. The second wire harnesses to be added can be retrofitted to the first wire harness in a state in which the first wire harness has already been routed on the vehicle. Accordingly, a work load or work cost generated due to the change of the system configuration can be reduced greatly.

(5) A vehicular wire harness structure according to any of the aforementioned configurations (1) to (4), further including:

a third wire harness having one end that is connected to the second wire harness,

wherein the third wire harness has a sub control function portion that is provided at the other end of the third wire harness to control a third electrical component attached to the vehicle.

According to the vehicular wire harness structure having the aforementioned configuration (5), when the third electrical component is added, the main control function portion does not have to take charge of processing of the third electrical component. Therefore, the main control function portion does not have to have more capability than necessary. In addition, since processing capability of the sub control function portion can be adjusted in accordance with specifications of the third electrical component. Therefore, an increase in component cost of the sub control function portion can be suppressed. In addition, even when the third electrical component is added, it is unnecessary to entirely reproduce a new wire harness and replace the existing wire harness with the new wire harness, and the third electrical component to be added can be retrofitted to the second wire harness in a state in which the second wire harness has already been routed on the vehicle. Accordingly, a work load or work cost generated due to the change of the system configuration can be reduced greatly.

The vehicular wire harness structure according to the present invention is useful for optimizing the system configuration in accordance with specifications of any function to be added or any electrical component to be added. That is, when the second electrical component is added, the main control function portion does not have to take charge of processing of the second electrical component. Therefore, the main control function portion does not have to have more capability than necessary. In addition, processing capability of the sub control function portion can be adjusted in accordance with specifications of the second electrical component. Therefore, an increase in the component cost of the sub control function portion can be suppressed.

### BRIEF DESCRIPTION OF THE DRAWINGS

FIG. 1 is a block diagram showing a configuration example (1) of an on-vehicle system including a vehicular wire harness structure according to an embodiment of the present invention.

FIG. 2A to FIG. 2F are schematic views showing terminal specifications of single function slave electronic modules different in kind from one another.

FIG. 3 is a block diagram showing a configuration example of a single function salve electronic module used for an application whose control target is limited to an electric motor.

FIG. 4 is a block diagram showing a configuration example (2) of an on-vehicle system including a vehicular wire harness structure according to an embodiment of the present invention.

FIG. 5 is a block diagram showing a configuration example (3) of an on-vehicle system including a vehicular wire harness structure according to an embodiment of the present invention.

FIG. 6 is a block diagram showing a configuration example (4) of an on-vehicle system including a vehicular wire harness structure according to an embodiment of the present invention.

FIGS. 7A to 7D show a specific connection structure of a connection portion 23B in the configuration shown in FIG. 6, FIG. 7A being a partially broken perspective view of a harness branch connection mechanism, FIG. 7B being a plan view of a state in which an upper casing part of the harness branch connection mechanism shown in FIG. 7A is opened, FIG. 7C being a front view of the harness branch connection mechanism shown in FIG. 7A, FIG. 7D being a sectional view taken along a line A-A of the harness branch connection mechanism shown in FIG. 7A.

FIG. 8 is a schematic view showing a general configuration example of a case where a new electrical component or function is added to the on-vehicle system.

### DETAILED DESCRIPTION OF THE EXEMPLARY EMBODIMENTS

Specific embodiments about the present invention will be described below with reference to the respective drawings.

### First Embodiment

### <Configuration Example of On-Vehicle System>

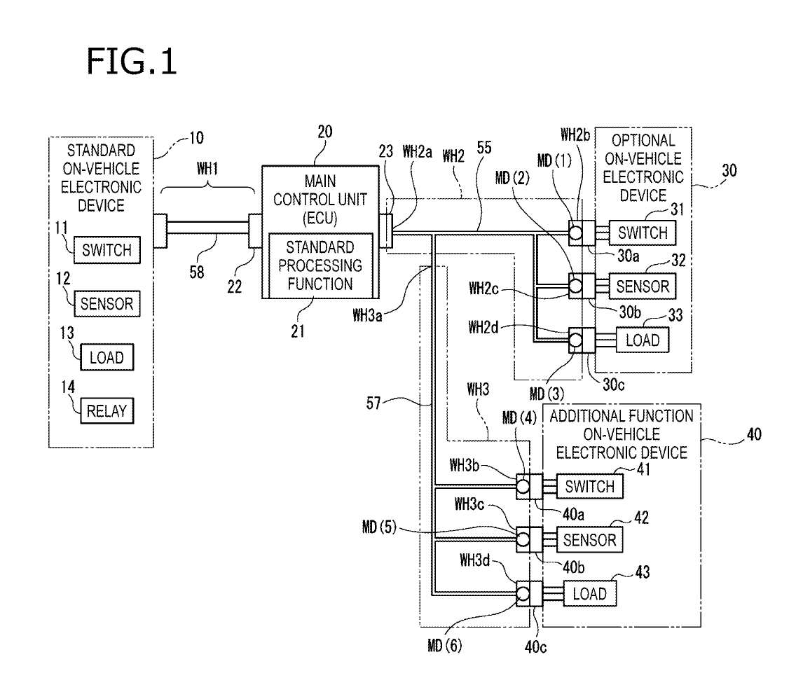

A configuration example (1) of an on-vehicle system including a vehicular wire harness structure according to an embodiment of the present invention is shown in FIG. 1.

The on-vehicle system shown in FIG. 1 includes a standard on-vehicle electronic device 10, an optional on-vehicle electronic device 30 and an additional function on-vehicle electronic device 40 as control targets. The standard on-vehicle electronic device 10 is an electronic device which is standardly mounted on all vehicles regardless of classification based on vehicle type or grade, etc. In the example of FIG. 1, the standard on-vehicle electronic device 10 includes a switch 11, a sensor 12, a load 13 and a relay 14. In actual vehicles, in all cases, a large number of standard on-vehicle electronic devices 10 are mounted on one vehicle.

The optional on-vehicle electronic device 30 is an electronic device that is selectively mounted on the vehicle in accordance with difference in vehicle type, difference in grade, difference in destination, user's selection, etc. In the example of FIG. 1, the optional on-vehicle electronic device 30 includes a switch 31, a sensor 32 and a load 33. In actual vehicles, in some cases, a plurality of optional on-vehicle electronic devices 30 are mounted on one vehicle, and in other cases, no optional on-vehicle electronic device 30 is provided on one vehicle.

The additional function on-vehicle electronic device 40 is an electronic device that can be additionally mounted on each vehicle in accordance with necessity, for example, due to an improvement, change of specifications, or the like, in a vehicle maker. In the example of FIG. 1, the additional function on-vehicle electronic device 40 includes a switch 41, a sensor 42 and a load 43. In actual vehicles, in some cases, a plurality of additional function on-vehicle electronic devices 40 are mounted on one vehicle, and in other cases, no additional function on-vehicle electronic device 40 is mounted on one vehicle.

A main control unit (ECU) 20 shown in FIG. 1 is a control portion that is standardly mounted on all vehicles regardless of the difference in vehicle type etc. The main control unit 20 is provided with a standard processing function 21 that controls only each standardly mounted electrical component like the standard on-vehicle electronic device 10 as a control target. In addition, the optional on-vehicle electronic device 30 and the additional function on-vehicle electronic device 40 are included in the on-vehicle system shown in FIG. 1. However, the main control unit 20 does not have a function for controlling the optional on-vehicle electronic device 30 and a function for controlling the additional function on-vehicle electronic device 40.

The main control unit 20 is provided with two connectors 22 and 23. In addition, a first wire harness WH1 electrically connects the connector 22 of the main control unit 20 and the standard on-vehicle electronic device 10 to each other.

The first wire harness WH1 is basically an aggregate of electric wires. Connectors are attached to end portions of the first wire harness WH1. Although not shown, the first wire harness WH1 is provided with an electric wire feeding power and a communication wire capable of making multiplex data communication. Incidentally, in place of or in addition to the communication wire capable of making the multiplex data communication, the first wire harness WH1 may be provided with a communication wire (direct wire) that directly inputs a signal outputted from the switch 11, the sensor 12, etc. to the main control unit 20. In addition, the first wire harness WH1 may be provided with an earth (ground) wire.

The standard processing function 21 of the main control unit 20 controls the standard on-vehicle electronic device 10 in accordance with contents of an incorporated program and a situation while making communication with the standard on-vehicle electronic device 10 through the communication wire of the first wire harness WH1. For example, the standard processing function 21 reads a state of the switch 11 or an output signal of the sensor 12 in the standard on-vehicle electronic device 10 and controls ON/OFF of electric conduction to the load 13, a duty cycle thereof, etc. or controls ON/OFF of the relay 14.

On the other hand, the connector 23 of the main control unit 20 and the optional on-vehicle electronic device 30 are electrically connected through a second wire harness WH2. The second wire harness WH2 is also basically an aggregate of electric wires. Connectors are attached to end portions of the second wire harness WH2. In the second wire harness WH2 shown in FIG. 1, a connector WH2a is connected to one end of an electric wire group 55, and the other end side of the electric wire group 55 is branched into three so that connectors WH2b, WH2c and WH2d are connected to end portions of the branched three respectively.

The connector WH2a of the second wire harness WH2 is connected to the connector 23 of the main control unit 20. In addition, the connectors WH2b, WH2c and WH2d of the second wire harness WH2 are connected to connectors 30a, 30b and 30c of the optional on-vehicle electronic device 30 respectively.

In addition, single function slave electronic modules MD(1), MD(2) and MD(3) are provided inside the connectors WH2b, WH2c and WH2d respectively. Here, the three single function slave electronic modules MD(1), MD(2) and MD(3) differ in kind from one another.

That is, an electronic circuit modularized to implement only a minimum function required for controlling the switch 31 inside the optional on-vehicle electronic device 30 connected to the connector 30a is selectively used as the single function slave electronic module MD(1) built in the connector WH2b. Accordingly, the main control unit 20 does not have to be mounted with the function for controlling the switch 31 of the optional on-vehicle electronic device 30. However, in the main control unit 20, a function for serving as a master to make data communication with the single function slave electronic module MD(1) is installed as the standard processing function 21.

In addition, an electronic circuit modularized to implement only a minimum function required for controlling the sensor 32 inside the optional on-vehicle electronic device 30 connected to the connector 30b is selectively used as the single function slave electronic module MD(2) built in the connector WH2c. Accordingly, the main control unit 20 does not have to be mounted with the function for controlling the sensor 32 of the optional on-vehicle electronic device 30. However, in the main control unit 20, a function for serving as a master to make data communication with the single function slave electronic module MD(2) is installed as the standard processing function 21.

In addition, an electronic circuit modularized to implement only a minimum function required for controlling the load 33 inside the optional on-vehicle electronic device 30 connected to the connector 30c is selectively used as the single function slave electronic module MD(3) built in the connector WH2d. Accordingly, the main control unit 20 does not have to be mounted with the function for controlling the load 33 of the optional on-vehicle electronic device 30. However, in the main control unit 20, a function for serving as a master to make data communication with the single function slave electronic module MD(3) is installed as the standard processing function 21.

On the other hand, the on-vehicle system in FIG. 1 is provided with a third wire harness WH3 in order to make connection with the additional function on-vehicle electronic device 40. The third wire harness WH3 is also basically an aggregate of electric wires. Connectors are attached to end portions of the third wire harness WH3. In the third wire harness WH3 shown in FIG. 1, a connector WH3a is connected to one end of an electric wire group 57, and the other end side of the electric wire group 57 is branched into three so that connectors WH3b, WH3c and WH3d are connected to end portions of the branched three respectively.

The connector WH3a of the third wire harness WH3 is connected in the middle of the electric wire group 55 constituting the second wire harness WH2. In addition, the connectors WH3b, WH3c and WH3d of the third wire harness WH3 are connected to connectors 40a, 40b and 40c of the additional function on-vehicle electronic device 40 respectively.

In addition, single function slave electronic modules MD(4), MD(5) and MD(6) are provided inside the connector WH3b, WH3c and WH3d respectively. Here, the three single function slave electronic modules MD(4), MD(5) and MD(6) differ in kind from one another.

That is, an electronic circuit modularized to implement only a minimum function required for controlling the switch 41 inside the additional function on-vehicle electronic device 40 connected to the connector 40a is selectively used as the single function slave electronic module MD(4) built in the connector WH3b. Accordingly, the main control unit 20 does not have to be mounted with the function for controlling the switch 41 of the additional function on-vehicle electronic device 40. Incidentally, in the main control unit 20, a function for serving as a master to make data communication with the single function slave electronic module MD(4) is installed as the standard processing function 21.

In addition, an electronic circuit modularized to implement only a minimum function required for controlling the sensor 42 inside the additional function on-vehicle electronic device 40 connected to the connector 40b is selectively used as the single function slave electronic module MD(5) built in the connector WH3c. Accordingly, the main control unit 20 does not have to be mounted with the function for controlling the sensor 42 of the additional function on-vehicle electronic device 40. In addition, the standard processing function 21 of the main control unit 20 has a function for serving as a master to make data communication with the single function slave electronic module MD(5).

In addition, an electronic circuit modularized to implement only a minimum function required for controlling the load 43 inside the additional function on-vehicle electronic device 40 connected to the connector 40c is selectively used as the single function slave electronic module MD(6) built in the connector WH3d. Accordingly, the main control unit 20 does not have to be mounted with the function for controlling the load 43 of the additional function on-vehicle electronic device 40. In addition, the standard processing function 21 of the main control unit 20 has a function for serving as a master to make data communication with the single function slave electronic module MD(6).

### <Specific Examples of Specifications of Single Function Slave Electronic Modules MDs>

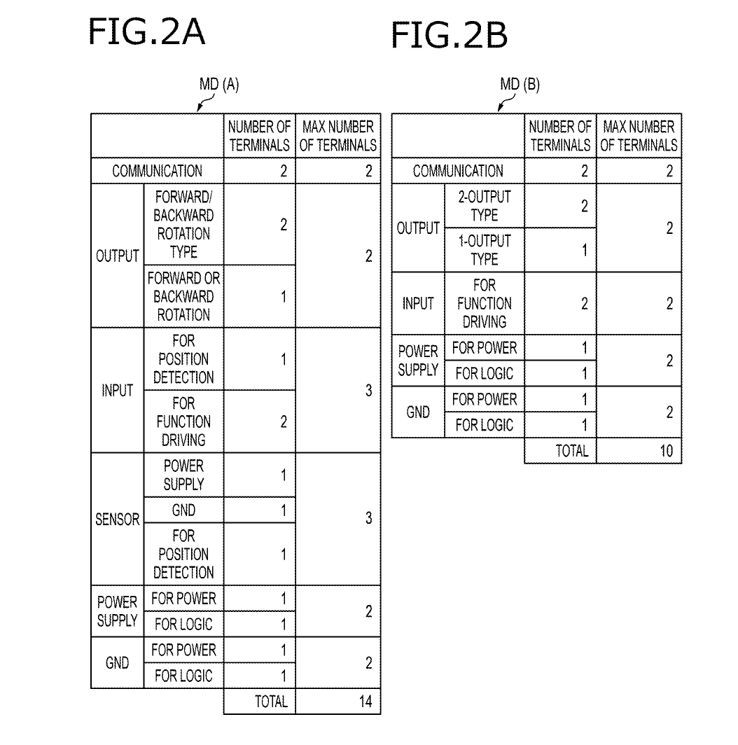

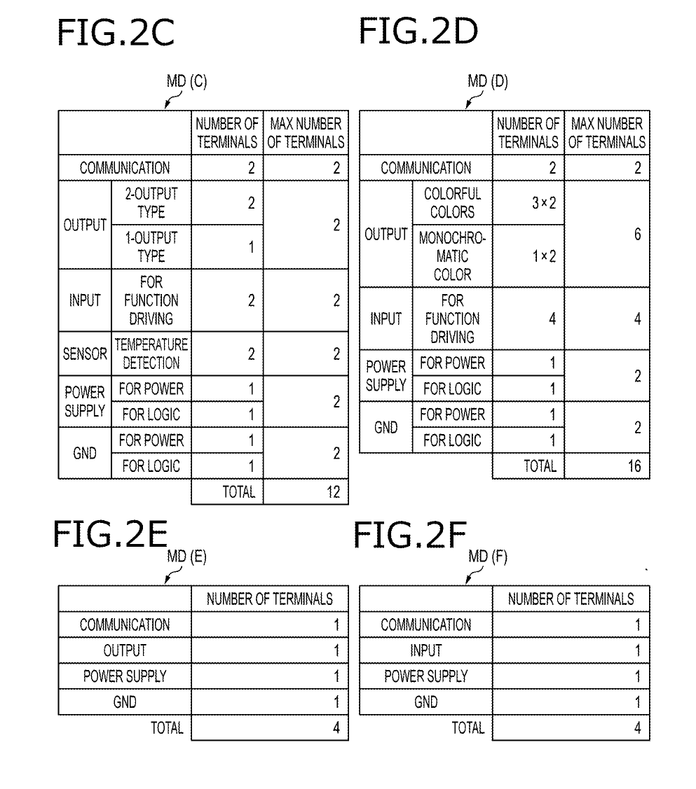

Terminal specifications of six single function slave electronic modules MDs differing in kind from one another are shown in FIGS. 2A to 2F respectively.

A single function slave electronic module MD(A) shown in FIG. 2A serves as a modularized electronic circuit that is minimized to implement a function as a slave limited to a function of controlling an electric motor. When, for example, the load 33 inside the optional on-vehicle electronic device 30 shown in FIG. 1 is the electric motor, the single function slave electronic module MD(A) can be selectively used as the single function slave electronic module MD(3) inside the connector WH2d.

As shown in FIG. 2A, the single function slave electronic module MD(A) can be provided with communication terminals (two at most), output terminals (two at most), input terminals (three at most), sensor terminals (three at most), power supply terminals (two at most), and earth (GND) terminals (two at most). That is, the maximum number of the terminals of the single function slave electronic module MD(A) is 14.

A single function slave electronic module MD(B) shown in FIG. 2B is a modularized electronic circuit that is minimized to implement a function as a slave limited to a function of controlling a heater. When, for example, the load 43 inside the additional function on-vehicle electronic device 40 shown in FIG. 1 is the heater, the single function slave electronic module MD(B) is selectively used as the single function slave electronic module MD(6) inside the connector WH3d.

As shown in FIG. 2B, the single function slave electronic module MD(B) can be provided with communication terminals (two at most), output terminals (two at most), input terminals (two at most), power supply terminals (two at most), and earth (GND) terminals (two at most). That is, the maximum number of the terminals of the single function slave electronic module MD(B) is 10.

A single function slave electronic module MD(C) shown in FIG. 2C is a modularized electronic circuit that is minimized to implement a function as a slave limited to a function of controlling a lamp. When, for example, the load 43 inside the additional function on-vehicle electronic device 40 shown in FIG. 1 is the lamp, the single function slave electronic module MD(C) is selectively used as the single function slave electronic module MD(6) inside the connector WH3d.

As shown in FIG. 2C, the single function slave electronic module MD(C) can be provided with communication terminals (two at most), output terminals (two at most), input terminals (two at most), sensor terminals (two at most), power supply terminals (two at most), and earth (GND) terminals (two at most). That is, the maximum number of the terminals of the single function slave electronic module MD(C) is 12.

A single function slave electronic module MD(D) shown in FIG. 2D is a modularized electronic circuit that is minimized to implement a function as a slave limited to a function of controlling an LED (Light-Emitting Diode). When, for example, the load 43 inside the additional function on-vehicle electronic device 40 shown in FIG. 1 is the LED, the single function slave electronic module MD(D) is selectively used as the single function slave electronic module MD(6) inside the connector WH3d.

As shown in FIG. 2D, the single function slave electronic module MD(D) can be provided with communication terminals (two at most), output terminals (six at most), input terminals (four at most), power supply terminals (two at most), and earth (GND) terminals (two at most). That is, the maximum number of the terminals of the single function slave electronic module MD(D) is 16.

A single function slave electronic module MD(E) shown in FIG. 2E is a modularized electronic circuit that serves for implementing a function as a slave limited to a minimum function for outputting a signal. When, for example, the load 43 inside the additional function on-vehicle electronic device 40 shown in FIG. 1 is an output element that is very simple and consumes little power, the single function slave electronic module MD(E) is selectively used as the single function slave electronic module MD(6) inside the connector WH3d.

As shown in FIG. 2E, the single function slave electronic module MD(E) can be provided with a communication terminal (one at most), an output terminal (one at most), a power supply terminal (one at most), and an earth (GND) terminal (one at most). That is, the maximum number of the terminals of the single function slave electronic module MD(E) is 4.

A single function slave electronic module MD(F) shown in FIG. 2F is a modularized electronic circuit that serves for implementing a function as a slave limited to a minimum function for inputting a signal. For example, in order to read a state of the switch 41 inside the additional function on-vehicle electronic device 40 shown in FIG. 1 and to transmit the read state to a control element which requires information of the state by communication, the single function slave electronic module MD(F) is selectively used as the single function slave electronic module MD(4) inside the connector WH3b.

### <Configuration Example of Single Function Slave Electronic Module MD>

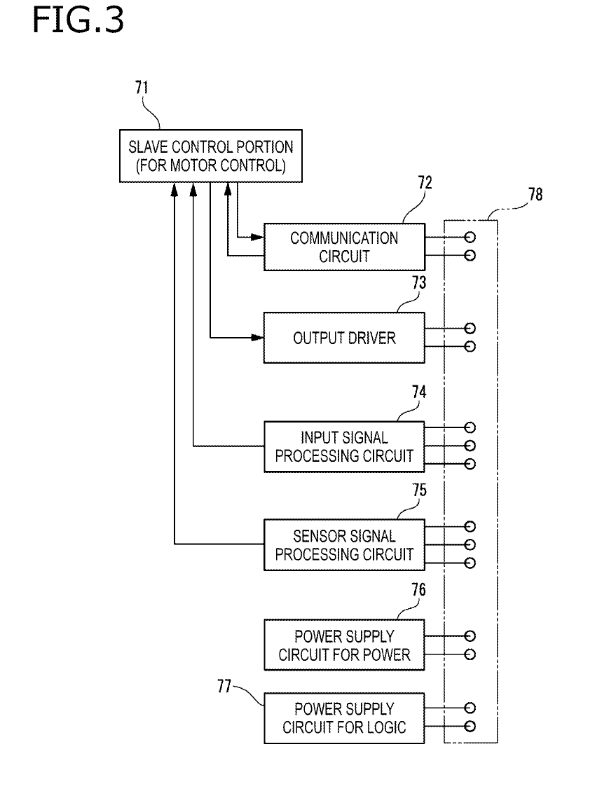

A configuration example of a single function slave electronic module used for an application in which an electrical component as a control target is limited to an electric motor is shown in FIG. 3. That is, a specific configuration example of the single function slave electronic module MD(A) agreeing with the specifications shown in FIG. 2A is shown in FIG. 3.

The single function slave electronic module MD(A) shown in FIG. 3 is provided with a slave control portion 71, a communication circuit 72, an output driver 73, an input signal processing circuit 74, a sensor signal processing circuit 75, a power supply circuit 76 for power, a power supply circuit 77 for logic, and a connection terminal group 78.

The slave control portion 71 is constituted by a microcomputer. A function, i.e. a program required for controlling the respective circuits inside the module and the electric motor connected as a load to the respective circuits inside the module is built in the slave control portion 71 in advance.

The communication circuit 72 is provided with a multiplex communication function which is required for allowing the slave control portion 71 to transmit and receive data through the communication wire on the wire harness. In order to make connection with the outside of the module, the communication circuit 72 is provided with a data transmission terminal and a data reception terminal. Incidentally, the communication circuit 72 may be designed to be provided with a data transmission/reception terminal when a standard such as LIN (Local Interconnect Network) communication or CXPI (Clock Extension Peripheral Interface) communication based on which bidirectional communication is performed by a single wire is used.

The output driver 73 is a circuit that outputs a control signal in order to perform changeover between electric conduction and electric non-conduction to the electric motor of the control target connected as the load. The output driver 73 has two output terminals in order to make it possible to perform changeover between forward rotation and backward rotation of a driving direction of the electric motor connected to the outside of the module.

The input signal processing circuit 74 can receive three signals inputted from the outside of the module from different terminals from one another, convert the received three signals into a signal suitable for processing of the salve control portion 71, and give the converted signal to the slave control portion 71.

The sensor signal processing circuit 75 has a function for feeding power supply power to the sensor for detecting the position of the motor, receiving signals from the sensor and giving the position information required by the slave control portion 71 to the slave control portion 71.

The power supply circuit 76 for power has a function for feeding suitable power to the respective power-relevant circuits inside the module. The power supply circuit 77 for logic has a function for feeding suitable power to the respective logic-relevant circuits inside the module.

The connection terminal group 78 of the module shown in FIG. 3 is provided with the fourteen terminals to agree with the terminal specifications of the single function slave electronic module MD(A) shown in FIG. 2A.

Incidentally, although not shown, each of the single function slave electronic modules MD(B) to MD(F) shown in FIG. 2 has a control portion providing a function of controlling a control target in a similar manner to or the same manner as the slave control portion 71 of FIG. 3. In addition, each of the control portions of the single function slave electronic modules MD(E), MD(F) etc. executing only a simple function does not always have to use a microcomputer but may be constituted by only a logic circuit performing simple processing.

### <Relation Between Connectors of Wire Harness and Modules>

Accordingly, when, for example, the load 43 is an electric motor in the additional function on-vehicle electronic device 40 of the on-vehicle system shown in FIG. 1, the module MD(A) shown in FIG. 2A and FIG. 3 is selected from the six single function slave electronic modules MD(A) to MD(F) shown in FIG. 2 and provided as the single function slave electronic module MD(6) inside the connector WH3d.

Thus, one is selected from the six single function slave electronic modules MD(A) to MD(F) and provided in each of the connectors of the second wire harness WH2 and the third wire harness WH3. Thus, a single electrical component as the control target can be controlled by only the module whose function or capability is optimized to the requisite minimum.

As for the number of terminals at places where the connectors WH2b, WH2c and WH2d of the second wire harness WH2 and the connectors 30a, 30b and 30c of the connection destinations are connected to each other respectively, the number of terminals can be made common among all the connectors. The same thing is also applied to the number of terminals at places where the connectors WH3b, WH3c and WH3d of the third wire harness WH3 and the connectors 40a, 40b and 40c of the connection destinations are connected to each other respectively.

For example, among the six single function slave electronic modules MD(A) to MD(F) shown in FIG. 2, the number of terminals changes within a range of from 4 to 16 and the maximum number of terminals is 16. Accordingly, when the number of terminals in all the connectors WH2b, WH2c, WH2d, WH3b, WH3c, WH3d, 30a, 30b, 30c, 40a, 40b, 40c is set at 16, the shape or size can be made common among the connectors and reduction etc. of component cost can be achieved.

It is a matter of course that the number of terminals does not have to be unified but may be optimized for each of the connectors. When, for example, the load 43 inside the additional function on-vehicle electronic device 40 shown in FIG. 1 is an electric motor and the number of electric wires actually connected to the load 43 is 10, it is estimated that the total number of terminals of the connector 40c is set at 10 and the total number of terminals of the connector WH3d is also set at 10 accordingly.

Incidentally, the single second wire harness WH2 is connected to the main control unit 20 in the on-vehicle system shown in FIG. 1. When, for example, a plurality of optional on-vehicle electronic devices 30 are present at different regions on the vehicle, a plurality of second wire harnesses WH2 may be provided so that one ends of the second wire harnesses WH2 can be connected to the main control unit 20 respectively. Further, a plurality of third wire harnesses WH3 may be provided so that one ends of the third wire harnesses WH3 can be connected to the main control unit 20 or the second wire harnesses WH2 respectively.

### <Advantages of Vehicular Wire Harness Structure According to First Embodiment>

Even when the optional on-vehicle electronic device 30 or the additional function on-vehicle electronic device 40 is connected in the on-vehicle system shown in FIG. 1, only the standard processing function 21 is mounted in the main control unit 20. Therefore, the main control unit 20 does not have to have more capability than necessary so that the component cost can be reduced.

In addition, even when an electrical component or a function that was not assumed in original design of the vehicle, like the additional function on-vehicle electronic device 40, is added, only the kind of the single function slave electronic module MD provided in each of the connectors WH3b, WH3c and WH3d of the third wire harness WH3 is suitably selected so that the function required for control can be optimized in accordance with the specifications of the additional function on-vehicle electronic device 40. That is, it is possible to construct an on-vehicle system that is optimal in terms of flexibility and scalability in accordance with the function to be added.

In addition, when no additional function on-vehicle electronic device 40 is used, the third wire harness WH3 can be dispensed with so that an overall configuration of the wire harness can be simplified. In addition, when no optional on-vehicle electronic device 30 is used, the second wire harness WH2 can be dispensed with so that the overall configuration of the wire harness can be simplified.

### Second Embodiment

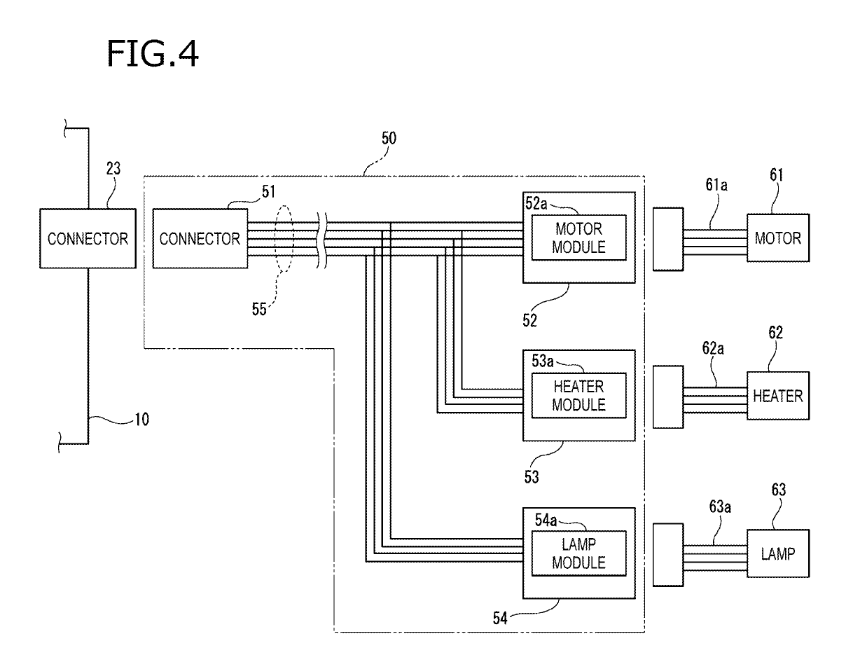

A configuration example (2) of an on-vehicle system including a vehicular wire harness structure according to an embodiment of the present invention is shown in FIG. 4. The on-vehicle system shown in FIG. 4 is a modification of the on-vehicle system shown in FIG. 1. In addition, a wire harness 50 shown in FIG. 4 corresponds to the second wire harness WH2 or the third wire harness WH3 in FIG. 1.

Assume a case where a motor 61, a heater 62 and a lamp 63 serving as optional on-vehicle electrical components or additional on-vehicle electrical components are connected to a standard on-vehicle electronic device 10 in the on-vehicle system shown in FIG. 4. That is, a connector 23 of the standard on-vehicle electronic device 10 is connected with the motor 61, the heater 62 and the lamp 63 which are the on-vehicle electrical components, by use of the wire harness 50.

The wire harness 50 is mainly constituted by an electric wire group 55 which is an aggregate of electric wires. In addition, a connector 51 is attached to one end of the electric wire group 55, and the other end side of the electric wire group 55 is branched into three lines. Connectors 52, 53 and 54 are attached to end portions of the three lines respectively.

A motor module 52a is mounted inside the connector 52. A heater module 53a is mounted inside the connector 53. A lamp module 54a is mounted inside the connector 54. Here, the motor module 52a corresponds to the single function slave electronic module MD(A) shown in FIG. 2A. The heater module 53a corresponds to the single function slave electronic module MD(B) shown in FIG. 2B. The lamp module 54a corresponds to the single function slave electronic module MD(C) shown in FIG. 2C.

Incidentally, the electric wire group 55 constituting the wire harness 50 at least includes one electric wire for feeding power supply power and one electric wire for communication. In addition, in some cases, the electric wire group 55 may also include an earth wire. Further, one or more other electric wires may be added to the electric wire group in accordance with necessity.

As shown in FIG. 4, the connector 52 of the wire harness 50 is connected to the motor 61 through an electrical component connection sub harness 61a. In addition, the connector 53 is connected to the heater 62 through an electrical component connection sub harness 62a. In addition, the connector 54 is connected to the lamp 63 through an electrical component connection sub harness 63a.

Accordingly, in the on-vehicle system shown in FIG. 4, a slave control portion 71 inside the motor module 52a controls the motor 61, a control portion inside the heater module 53a controls the heater 62, and a control portion inside the lamp module 54a controls the lamp 63.

### Third Embodiment

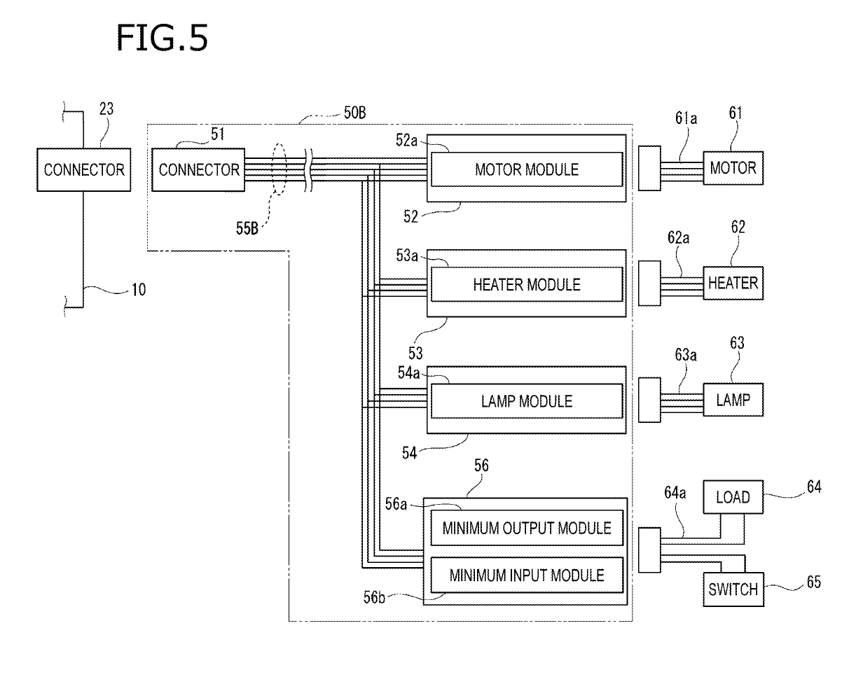

A configuration example (3) of an on-vehicle system including a vehicular wire harness structure according to an embodiment of the present invention is shown in FIG. 5. The on-vehicle system shown in FIG. 5 is a modification of the on-vehicle system shown in FIG. 4. In addition, a wire harness 50B shown in FIG. 5 corresponds to the second wire harness WH2 or the third wire harness WH3 in FIG. 1.

Assume a case where a motor 61, a heater 62, a lamp 63, a load 64, and a switch 65 serving as optional on-vehicle electrical components or additional on-vehicle electrical components are connected to a standard on-vehicle electronic device 10 in the on-vehicle system shown in FIG. 5. That is, a connector 23 of the standard on-vehicle electronic device 10 is connected with the motor 61, the heater 62, the lamp 63, the load 64 and the switch 65 which are the on-vehicle electrical components, by use of the wire harness 50B.

The wire harness 50B is mainly constituted by an electric wire group 55B that is an aggregate of electric wires. In addition, a connector 51 is attached to one end of the electric wire group 55B. The other end side of the electric wire group 55B is branched into four lines. Connectors 52, 53, 54 and 56 are attached to end portions of the four lines respectively.

A motor module 52a is mounted inside the connector 52. A heater module 53a is mounted inside the connector 53. A lamp module 54a is mounted inside the connector 54. In addition, two modules, i.e. a minimum output module 56a and a minimum input module 56b are mounted inside the connector 56.

Here, the motor module 52a corresponds to the single function slave electronic module MD(A) shown in FIG. 2A, the heater module 53a corresponds to the single function slave electronic module MD(B) shown in FIG. 2B, and the lamp module 54a corresponds to the single function slave electronic module MD(C) shown in FIG. 2C. In addition, the minimum output module 56a corresponds to the single function slave electronic module MD(E) shown in FIG. 2E, and the minimum input module 56b corresponds to the single function slave electronic module MD(F) shown in FIG. 2F.

Incidentally, the electric wire group 55B constituting the wire harness 50B at least includes one electric wire for feeding power supply power and one electric wire for communication. In addition, in some cases, the electric wire group may also include an earth wire. Further, one or more other electric wires may be also added to the electric wire group 55B in accordance with necessity.

As shown in FIG. 5, the connector 52 of the wire harness 50B is connected to the motor 61 through an electrical component connection sub harness 61a. In addition, the connector 53 is connected to the heater 62 through an electrical component connection sub harness 62a. In addition, the connector 54 is connected to the lamp 63 through an electrical component connection sub harness 63a. In addition, the connector 56 is connected to the load 64 and the switch 65 through an electrical component connection sub harness 64a.

Accordingly, in the on-vehicle system shown in FIG. 5, a slave control portion 71 inside the motor module 52a controls the motor 61, a control portion inside the heater module 53a controls the heater 62, and a control portion inside the lamp module 54a controls the lamp 63. In addition, a control portion inside the minimum output module 56a controls the load 64, and a control portion inside the minimum input module 56b controls the switch 65.

The maximum number of terminals in both the single function slave electronic modules MD(E) and MD(F) shown in FIG. 2 is 4. Accordingly, even when the two modules, i.e. the minimum output module 56a and the minimum input module 56b are built in the connector 56 shown in FIG. 5, the total number of terminals of the minimum output module 56a and the minimum input module 56b does not exceed 16 that is the maximum number of terminals of the single function slave electronic modules MD(A) to MD(F).

That is, even when a plurality of modules are mounted inside one connector in a case where the modules each having a small number of terminals like the single function slave electronic modules MD(E) and MD(F) are used, it is unnecessary to increase the total number of terminals of the connector. Accordingly, it is possible to mount the plurality of modules in each connector without changing specifications of the connector.

### Fourth Embodiment

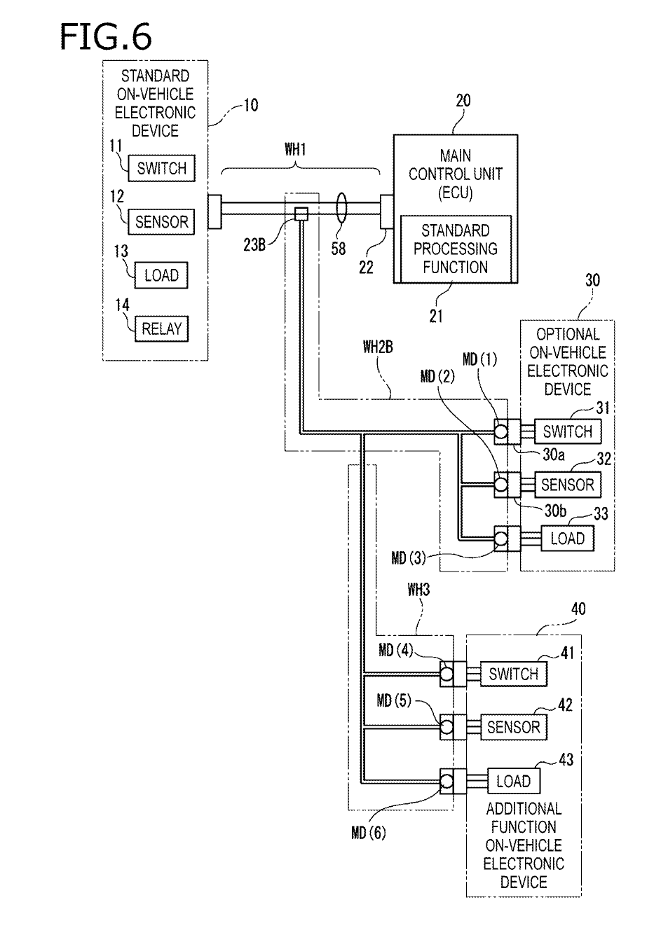

A configuration example (4) of an on-vehicle system including a vehicular wire harness structure according to an embodiment of the present invention is shown in FIG. 6. The on-vehicle system shown in FIG. 6 is a modification of the on-vehicle system shown in FIG. 1. In addition, a second wire harness WH2B shown in FIG. 6 corresponds to a modification of the second wire harness WH2 in FIG. 1.

In the on-vehicle system shown in FIG. 6, a standard on-vehicle electronic device 10 is connected to a main control unit 20 by a first wire harness WH1, a connection portion 23B provided at one end of the second wire harness WH2B is connected to an intermediate portion of the first wire harness WH1. Configurations of the second wire harness WH2B except the connection portion 23B and a third wire harness WH3 are similar to or the same as those in the on-vehicle system of FIG. 1.

When the connection portion 23B of the second wire harness WH2B is connected to the intermediate portion of the first wire harness WH1 as in FIG. 6, the second wire harness WH2B and the third wire harness WH3 can be retrofitted in accordance with necessity and the number of connectors on the main control unit 20 can be reduced.

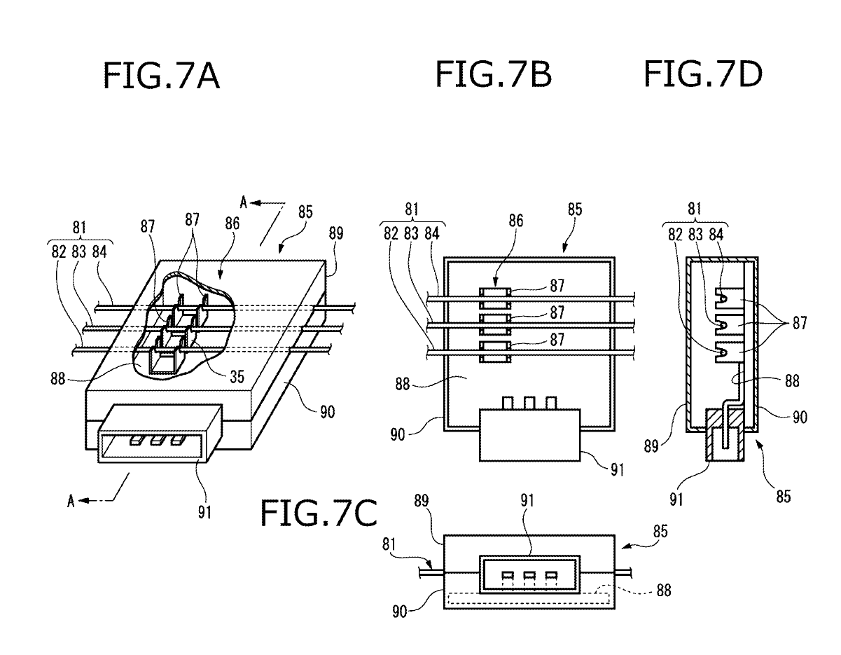

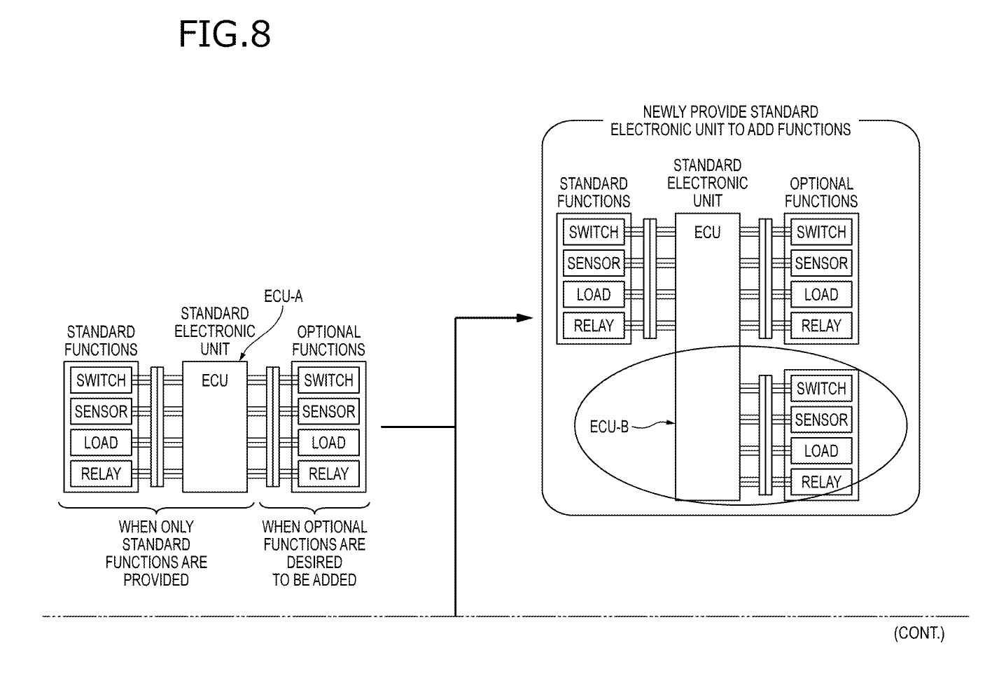

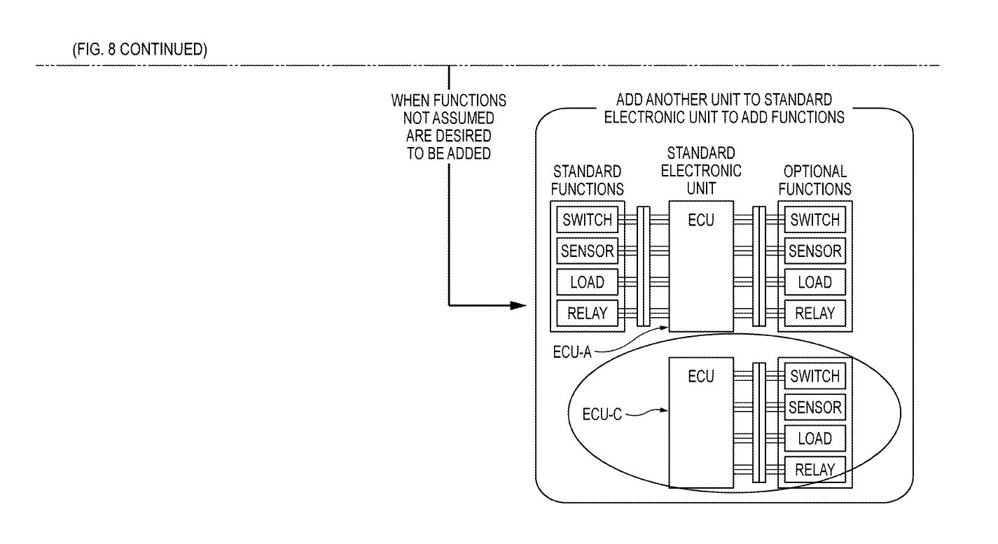

A specific example when the connection portion 23B of the second wire harness WH2B is retrofitted to the first wire harness WH1 is shown in FIG. 7A to 7D. FIG. 7A is a partially broken perspective view of a harness branch connection mechanism. FIG. 7B is a plan view of a state in which an upper casing part of the harness branch connection mechanism shown in FIG. 7A is opened. FIG. 7C is a front view of the harness branch connection mechanism shown in FIG. 7A. FIG. 7D is a sectional view taken along a line A-A of the harness branch connection mechanism shown in FIG. 7A.

For example, the connection portion 23B at one end of the second wire harness WH2B shown in FIG. 6 is connected to a board mounting connector 91 shown in FIG. 7. Thus, the second wire harness WH2B is branch-connected to a desired position of a basic harness 81 included in an electric wire group 58 of the first wire harness WH1 through a harness branch connection mechanism 85.

The harness branch connection mechanism 85 shown in FIG. 7 has a pressure contact portion 86 that is connected with conductors of the connection portion 23B and connected by pressure contact with conductors of the basic harness 81. The pressure contact portion 86 is constituted by, for example, pairs of pressure contact blades 87 standing erectly, and connected to a predetermined circuit of a circuit board 88. The circuit board 88 is received inside a casing that is made of an insulating resin and that is constituted by an upper casing part 89 and a lower casing part 90. The upper casing part 89 and the lower casing part 90 are coupled to each other openably/closably, for example, by use of thin hinges (not shown).

A power supply wire 82, a communication wire 83, and an earth wire 84 included in the basic harness 81 are respectively and individually held by the upper casing part 89 and the lower casing part 90 of the harness branch connection mechanism 85. Thus, insulating coatings of the electric wires are cut by the pressure contact blades 87 so that the pressure contact portion 86 is connected by pressure contact with the conductors of the respective electric wires. The harness branch connection mechanism 85 holding the power supply wire 82, the communication wire 83 and the earth wire 84 of the basic harness 81 can be fixed to a desired position of the basic harness 81 due to the upper casing part 89 and the lower casing part 90 locked to each other. The circuit of the harness branch connection mechanism 85 connected with the basic harness 81 is connected with the connection portion 23B of the second wire harness WH2B through the board mounting connector 91 provided on the circuit board 88.

When the connection structure shown in FIG. 7 is used, the connection portion 23B of the second wire harness WH2B is easily additionally connected to a desired place on the first wire harness WH1 in a retrofitting manner in a state in which the first wire harness WH1 has already been mounted on a vehicle body.

Incidentally, when the earth of the vehicle body is used, the earth wire 84 in the basic harness 81 can be also dispensed with. In addition, the connection using pressure contact as shown in FIG. 7 can be also replaced, for example, by connection using another method such as soldering.

In addition, a connection structure at a place where, for example, the connector WH3a of the third wire harness WH3 shown in FIG. 1 is connected to the second wire harness WH2 can be also retrofitted by use of the harness branch connection mechanism 85 shown in FIG. 7. Due to the connector WH3a of the third wire harness WH3 connected to the second wire harness WH2 the number of connectors mounted in the main control unit 20 can be reduced. Accordingly, it is possible to reduce component cost when no optional on-vehicle electronic device 30 or no additional function on-vehicle electronic device 40 is mounted on the vehicle.

Here, the aforementioned characteristics of the embodiments of the vehicular wire harness structure according to the present invention will be briefly summarized and listed in the following configurations [1] to [5] respectively.

[1] A vehicular wire harness structure including:

a first wire harness (WH1) configured to connect a first electrical component (a standard on-vehicle electronic device 10) and a main control function portion (a main control unit 20) with each other, the first electrical component being attached to a vehicle, the main control function portion controlling the first electrical component; and

a second wire harness (WH2) that has one end connected to the main control function portion; wherein:

the second wire harness (WH2) has a sub control function portion (a single function slave electronic module MD) that is provided at the other end (a connector WH2b, WH2c, WH2d) of the second wire harness to control a second electrical component (an optional on-vehicle electronic device 30 or an additional function on-vehicle electronic device 40) attached to the vehicle.

[2] A vehicular wire harness structure according to the aforementioned configuration [1], wherein the sub control function portion of the second wire harness has a single function that controls any one of a plurality of electrical components each of which serves as the second electrical component (see FIG. 2).
[3] A vehicular wire harness structure according to the aforementioned configuration [1], wherein the sub control function portion has a plurality of functions (a connector 56 in FIG. 5) that control at least two (a load 64 and a switch 65) of a plurality of electrical components each of which serves as the second electrical component, and controls the second electrical components connected to the sub control function portion.
[4] A vehicular wire harness structure according to one of the aforementioned configurations [1] to [3], wherein a plurality of wire harnesses each of which serves as the second wire harness are provided; and

wherein the plurality of the second wire harnesses are connected to the first wire harness respectively.

[5] A vehicular wire harness structure according to one of the aforementioned configurations [1] to [4], further including:

a third wire harness (WH3) having one end that is connected to the second wire harness,

wherein the third wire harness has a sub control function portion (a single function slave electronic module MD) that is provided at the other end (a connector WH3b, WH3c. WH3d) of the third wire harness to control a third electrical component attached to the vehicle (see FIG. 1).

Although the present invention has been described in detail with reference to specific embodiments, it is obvious to those skilled in the art that various changes or modifications can be made without departing from the spirit and scope of the present invention.

According to the present invention, the following effect is obtained. That is, it is possible to provide a wire harness structure that is useful for optimizing a system configuration in accordance with specifications of a function to be added or an electrical component to be added. The present invention obtaining the effect is useful about a vehicular wire harness structure.

What is claimed is:

1. A vehicular wire harness structure comprising:
a first wire harness configured to connect a first electrical component and a main control function portion with each other, the first electrical component being attached to a vehicle, the main control function portion controlling the first electrical component; and
a second wire harness that has one end connected to the main control function portion,
wherein the second wire harness has a sub control function portion that is provided at the other end of the second wire harness to control a second electrical component that is selectable whether to be attached to the vehicle or not; and
wherein a function for serving as a master to make a data communication with the sub control function portion which serves as a slave is installed in advance into the main control function portion and the main control function portion has no function to control the second electrical component.

2. The vehicular wire harness structure according to claim 1, wherein the sub control function portion of the second wire harness has a single function that controls any one of a plurality of electrical components each of which serves as the second electrical component.

3. The vehicular wire harness structure according to claim 1, wherein the sub control function portion has a plurality of functions that control at least two of a plurality of electrical components each of which serves as the second electrical component, and controls the second electrical components connected to the sub control function portion.

4. The vehicular wire harness structure according to claim 1, wherein a plurality of wire harnesses each of which serves as the second wire harness are provided; and
wherein the plurality of the second wire harnesses are connected to the first wire harness respectively.

5. The vehicular wire harness structure according to claim 1, further comprising:
a third wire harness having one end that is connected to the second wire harness,
wherein the third wire harness has a sub control function portion that is provided at the other end of the third wire harness to control a third electrical component attached to the vehicle.

6. The vehicular wire harness structure according to claim 1, wherein the first electrical component is a standard on-vehicle electronic device.
